(19) United States
(12) Patent Application Publication
(10) Pub. No.: US 2006/0262568 A1
(43) Pub. Date: Nov. 23, 2006

(54) Front light for diffusely reflecting displays

(75) Inventors: Saskia Maria Petrouchka Blom, Eindhoven (NL); Hugo Johan Cornelissen, Eindhoven (NL); Martin Jacobus Johan Jak, Eindhoven (NL); Pieter Joseph Clara Van Der Wel, Heerlen (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 10/555,050

(22) PCT Filed: Apr. 28, 2004
(86) PCT No.: PCT/IB04/50538

§ 371 Date: Oct. 28, 2005

(30) Foreign Application Priority Data
May 2, 2003 (EP) 031012289

(51) Int. Cl. F21V 7/04

(52) U.S. Cl. 362/625; 362/606; 362/621

(57) ABSTRACT

The present invention relates to a display apparatus, which has a diffusely reflecting display panel (21, 41, 51, 61, 71, 81, 91), light guide (23, 43, 53, 63, 73, 83, 93), a light source (22, 42, 52, 62, 72, 82, 92), and a transparent intermediate layer (29, 49, 59, 69), which is arranged between a front surface of said display panel and a rear surface (27, 47, 87, 97) of said light guide. The light source is mounted at an end (24, 84, 94) of the light guide. The display panel is in optical contact with said light guide, and the rear surface of the light guide is provided with a microstructure having wedge-facets (28, 34a-c, 48, 58) which are inclined to the front surface. Thereby a substantially uniform thickness of the light guide as well as a tuneable illumination uniformity are obtainable.

The present invention refers to diffusely reflecting displays, such as electrophoretic (E-ink) displays and Nanomat, which are often also called paper-like displays due to their physical character.

At low ambient light levels a display that has a reflective character needs a front light to illuminate the display. Traditional reflective displays, such as LCDs, require the illuminating light to reach the display surface at near normal angles therewith. Since the light source cannot be placed straight above that surface, but has to be located to the side of the display, there has been a development of transparent light guides, to be positioned above (in front of) the display surface, and to guide and redirect the light onto the display. In order to obtain a good light distribution and direction light guides have been provided with microstructures, such as saw tooth like microstructures at the front surface thereof The microstructures must be of high quality, and put high demands on the manufacturing thereof.

The introduction of diffusely reflecting displays, has relaxed the demands on the light guide of the front light, since they allow the illuminating light to reach the display surface at larger angles therewith. This advantage has triggered the development of simple wedge shaped light guides, which are easier to manufacture. Such a wedge shaped light guide is shown in EP 1 220 015, though for a reflection type LCD, which has a complicated additional reflector plate embedded in the display in order to simulate a more diffuse reflection character that makes it possible to use a wedge shaped light guide. However, those wedge shaped light guides have some disadvantages. First, such a light guide will be increasingly thick, at the end facing the light source, and undesirably heavy, when larger displays are to be illuminated or larger wedge angles are required. In addition to the problems of thickness and weight, integration of the front light with other parts is impeded. Further, the uniformity of the illumination cannot be tuned when a simple wedge is used.

The object of the present invention is to provide a diffusely reflecting display apparatus, which eliminates the front light drawbacks described above and provides for a front light which combines a substantially uniform thickness with the relaxed quality demands and with a tuneable illumination uniformity.

The object is achieved by means of a display apparatus according to claim 1.

Thus, according to an aspect of the invention, there is provided a display apparatus comprising a diffusely reflecting display panel, a front light comprising a light guide and a light source arranged at a first end of the light guide and emitting light, which enters into the light guide through said first end, and a transparent intermediate layer, which is arranged between a front surface of said display panel and a rear surface of said light guide, such that the display panel is in optical contact with said light guide. The rear surface of the light guide is provided with a microstructure comprising wedge-facets, which are arranged such that, for each wedge-facet, the distance between a first edge of the wedge-facet and said front surface of the display panel is shorter than the distance between a second edge of the wedge-facet and said front surface of the display panel, where said first edge is positioned closer to the light source than said second edge.

The expression “optical contact” is well known by a man skilled in the art and is defined as physical contact between different transparent materials that results in the zero or dark fringe of Newton's Rings experiment. This occurs at sufficiently small difference in refractive indices of the different materials. By “wedge-facet” is meant a facet that is inclined to a center plane of the light guide such that a portion of the light guide that defines the facet can be regarded as wedge shaped. This will be thoroughly exemplified below. By forming a microstructure comprising wedge-facets on the rear surface, or bottom, of the light guide and connecting it optically with the display panel by means of the intermediate transparent layer, the light diffusing properties of the diffusely reflecting display are advantageously used. Further, the optical quality of the microstructure need not be as high as when the microstructure is provided on the front surface, or top, of the light guide. In addition, the light guide as a whole need not be wedge shaped, thus eliminating the problem of large sized displays described above. However, within the scope of the invention, it is nevertheless possible, if desired, to make the front surface of the light guide non-parallel with the front surface of the display panel. Another advantage of the inventive display apparatus is that the microstructure is not exposed to the surrounding environment, which subject the top to dust particles, smear, scratching objects, etc. Further, the optical contact between the display and the microstructure of the light guide reduces the scattering of light due to non-sharp edges, scratches or other irregularities that may occur. Thus, the optical contact results in a better overall display performance.

In EP 1 220 015 indeed an embodiment of a light guide having a saw tooth shaped pattern on the rear surface of the light guide is shown. However, this prior art document basically is concerned with LCDs, and in particular with a modified variant of an LCD, as mentioned above, that does not imply the combination of a similar structure with a diffusely reflecting display.

According to an embodiment of the display apparatus the wedge-facets are arranged consecutively along the rear surface of the light guide, between the first end and a second end thereof, which second end is opposite to said first end. According to this embodiment the wedge-facets are arranged in a way that contributes to a uniform illumination.

According to an embodiment of the display apparatus, each two neighboring wedge-facets are connected by means of a connection surface, which is non-parallel with said front surface of the display panel. In other words, each connection surface extends from the second edge of a wedge-facet to the first edge of a consecutive wedge-facet. Due to the non-parallelism of the connection surfaces in combination with the orientation of the wedge-facets no light will hit these surfaces. Thus, the out coupling of light is only performed by the wedge-facets. Consequently, the finishing of the connection surfaces will be even less important.

According to an embodiment of the display apparatus, each two neighboring wedge-facets are connected by means of a connection surface, which consists of a first portion that is parallel with said front surface of the display panel and a second portion that is non-parallel with said front surface of the display panel. In this embodiment the wedge-facets are in a sense more separated from each other, due to the parallel portion. This means that the pitch of the wedge-facets is easily tuneable, which can be utilized in order to further improve the uniformity of the illumination.

According to an embodiment of the display apparatus, at least one wedge-facet property varies with the distance from said first end. This provides for further possibilities of tuning the illumination.

According to an embodiment of the display apparatus, said at least one wedge-facet property is chosen out of a group of wedge-facet properties consisting of the wedge angle, the distance between two consecutive connection surfaces, and the wedge pitch. In this embodiment several properties are possible to utilize for refining the distribution of the illumination on the display panel. For example this embodiment has a capability of obtaining a gradient in the out coupling rate by means of a proper positioning and shaping of the wedge-facets by varying one or more of the properties.

According to an embodiment of the display apparatus, said at least one wedge-facet property increases from said first end towards said second end. This embodiment defines one way of varying the property(ies).

According to embodiments of the display apparatus, an end surface of said first end comprises a first facet being non-perpendicular to a front surface of said light guide, or the end surface comprises also a second facet, which is adjacent to said first facet, wherein said first and second facets form a V-shaped groove extending along said end surface. In these embodiments the light entrance of the light guide is modified. Thereby, these embodiments provide an improvement to the incoupling of light into the light guide, which improvement aims at contributing to a uniform illumination.

According to an embodiment of the display apparatus, the intermediate layer is an adhesive. It is advantageous to apply an adhesive between the light guide and the display panel in order to obtain the intermediate layer, since it is easy to manufacture and since the adhesive easily fills up the cavities in the light guide that are obtained due to the microstructure.

According to an embodiment of the display apparatus it further comprises a touch screen and a second transparent intermediate layer, which is arranged between the touch screen and a front surface of said light guide, and which brings the touch screen into optical contact with the light guide. This embodiment extends the inventive concept for the basic display structure to touch screens, i.e. active displays, where input can be made on the display. This results in a significant improvement of the contrast and other properties of prior art touch screens.

According to an embodiment of the display apparatus the second transparent intermediate layer has a refractive index that is lower than that of the first transparent intermediate layer. This relation between the refractive indices of the first and second intermediate layers prevents the light from the light source from leaking into the touch screen, and thereby the light is out coupled towards the display panel only.

The present invention will be described in greater detail with reference made to the accompanying drawings, in which:

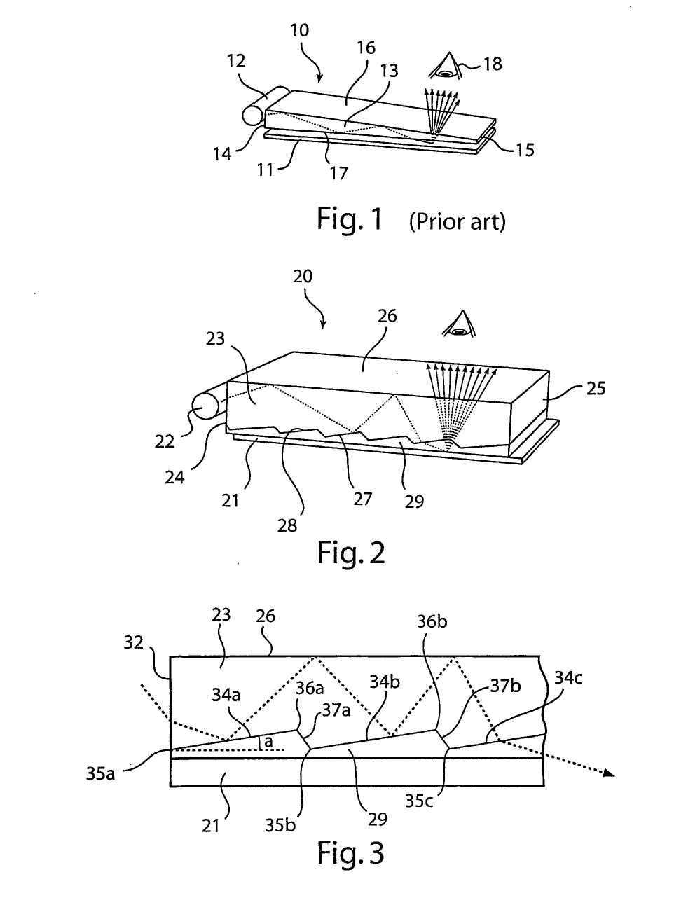

FIG. 1 in a perspective view, schematically shows a prior art display apparatus;

FIG. 2 in a perspective view, schematically shows an embodiment of the display apparatus according to the present invention;

FIG. 3 is an enlarged schematic side view of a portion of the display apparatus of FIG. 2; and

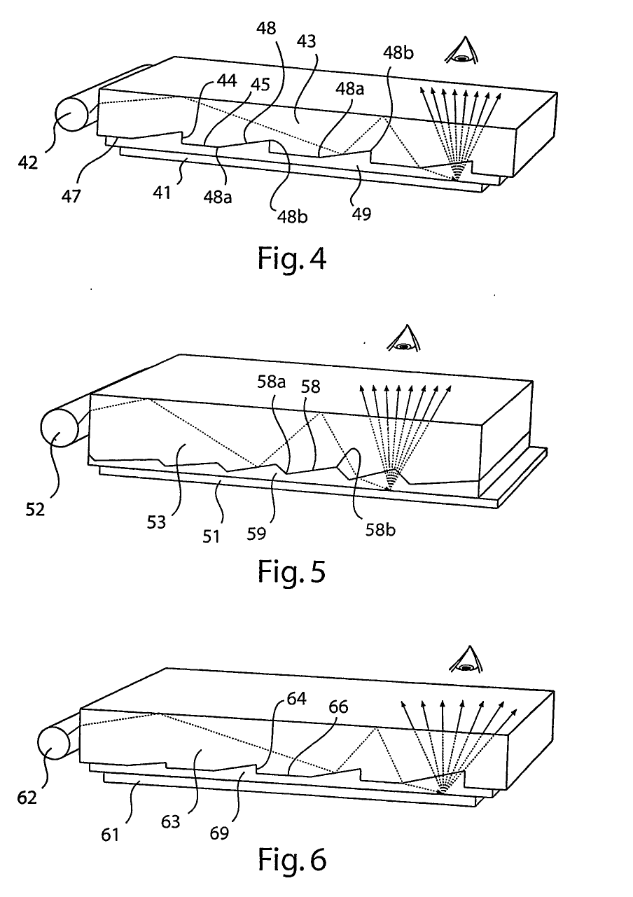

FIGS. 4-9 show further embodiments of the display apparatus according to the present invention.

In FIG. 1 a prior art display apparatus 10 is shown. It comprises a display panel 11 and a front light consisting of a light source 12 and a light guide 13. The display panel is of a diffusive reflecting type, which is illustrated by the reflected light rays that are spread over a large viewing angle. The light guide 13 is wedge shaped, such that a front surface 16 of the light guide is non-parallel, or inclined to a rear surface 17 thereof. The rear surface faces the display panel 11. The light source is positioned at a first thicker end 14 of the light guide 13, and the thickness of the light guide 13 is decreasing with the distance from the light source through a second thinner end 15 thereof, which is opposite to the first end 14. The light emitted from the light source is entered into the light guide 13 through the first end 14 and propagates along the light guide as illustrated by a light ray in FIG. 1. During the propagation the light ray is reflected alternately by the front surface 16 and the rear surface 17 of the light guide 13. Due to the inclined front surface 16 the angle of incidence of the light ray towards the rear surface 17 increases for each reflection by the front surface 16. Finally, the angle of incidence exceeds an upper limit for total reflection, and the light ray, or at least a part thereof, is out coupled through the rear surface 17 and hits the display panel 11. The display panel 11 reflects the light at a relatively distributed, or spread, way through the light guide and out into the surrounding air, where a viewer is situated, as represented in the Figure by a schematic eye 18. The interface, a thin intermediate layer, between the display panel 11 and the light guide 13 is air, which affects the out coupling angle in an undesired way.

In a first embodiment of the display apparatus 20 according to the present invention, as illustrated in FIG. 2, a display panel 21 and a light guide 23 are joined by means of an intermediate layer 29 consisting of an adhesive. The light guide 23 has a rear surface 27, which is provided with a microstructure of wedge-facets 28. The microstructure will be further explained below. The intermediate layer 29 provides optical contact between the light guide 23, and more particularly the wedge-facets 28, and the display panel 21. Preferably the adhesive 29 is a liquid glue, which easily and uniformly fills the cavities of the microstructure without leaving any air trapped between the intermediate layer 29 and the rear surface 27 of the light guide 23. The light guide 23 has a general block shape, where the front surface 26 of the light guide 23 is in parallel with the front surface of the display panel 21, and so is a geometric basic plane for the rear surface 27 of the light guide 23, although, in this embodiment, due to the wedge-facets 28, there are few surface portions of this rear surface 27 that are in fact located in that plane.

The refraction index of the intermediate layer 29 should be lower than that of the light guide 23. The refraction index of the intermediate layer 29 is adjustable in order to promote a uniform illumination, and, typically, this results in a refractive index substantially lower than that of the light guide 23. Consequently, the intermediate layer 29 is also called low index layer.

An exemplifying light ray introduced into the light guide 23, at a first end 24 thereof, from the light source 22, is propagated and reflected through the light guide 23 as shown in FIG. 2. The wedge-facets 28, at the rear surface 27 of the light guide 23, are inclined towards the first end 24. Due to the wedge-facets 28, the angle of incidence towards the wedge-facets 28 is increasing for each reflection against a wedge-facet 28, until the angle of full reflection is exceeded by the light ray.

In FIG. 3 the microstructure is shown in a further enlarged side view of a portion of the light guide as shown in FIG. 2. The wedge-facets 34a, 34b and 34c are arranged in series, i.e. consecutively, between the first end 24 and the second end 25 of the light guide 23. Each wedge-facet 34a-c is inclined such that a first end 35a-c of the facet 34a-c, that is closest to the light source, is located at a larger distance from the front surface 26 than a second end 36a-b of the facet 34a-c. Thus, at a local area of the light guide 23, the facet 34a-c provides the light guide 23 with a wedge shape. Each two neighboring wedge-facets 34a and 34b/34b and 34c are connected by means of a connection surface 37a-b, which is non-parallel with the front surface 26 of the display panel 21, and also non-parallel with an end surface 32 at the first end 24 of the light guide 23, which end surface 32, in turn, is perpendicular to the front surface 26. Thus, each second end 36a-b of a wedge-facet 34a-c is connected to a neighboring first end 35a-c of a consecutive wedge-facet 34a-c by means of such a connection surface. In this embodiment the connection surfaces 37a-b are almost perpendicular to the wedge-facets 34a-c, though they form an obtuse angle to the wedge-facets 34a-c. This results, as evident from FIG. 3, in that the connection surfaces 37a-b are not involved in the out coupling of light, and, consequently, their shape and surface finish are less important. For example they do not have to be planar but could be convex or concave, if that would facilitate the manufacture of the microstructure, or enhance some property of the microstructure.

A second embodiment of the display apparatus is shown in FIG. 4. In this embodiment the microstructure is different. More particularly, wedge-facets 48 at the rear surface of the light guide 43 are further separated from each other. Each two neighboring wedge-facets 48 are connected by means of a connection surface, which consists of a first portion 44 that is non-parallel with the front surface of the display panel 41 and a second portion 45 that is parallel with the front surface of the display panel 41. More particularly, in this embodiment, for each connection surface the first portion 44 is perpendicular to the front surface 46 of the light guide 43 and extends from the second end 48b of a preceding wedge-facet 48 down to the geometric plane of the rear surface 47 of the light guide 43. The second portion 45 extends in the geometric plane from the first portion 44 to the first end 48a of a consecutive wedge-facet 48. The extension of the second portions 45 is about the same as the extension of the wedge-facets 48.

Since the light source has to be positioned at an end of the light guide, there are difficulties in obtaining a uniform illumination of the display panel. In accordance with the invention it is possible to adapt the microstructure in such a way as to compensate for the side mounting of the light source. There are several different properties of the wedge-facets that are possible to adjust in dependence on the position of individual wedge-facets in relation to the light source. A major factor is the distance from an individual wedge-facet to the light source, above all the distance as measured in the direction of propagation of the light Wedge-facet properties of particular interest are the wedge angle, wedge length, the distance between two consecutive connection surfaces, and the wedge pitch. By wedge angle is meant the angle at which a wedge-facet is inclined in relation to the geometric plane of the rear surface of the light guide, as indicated by a in FIG. 3. By wedge pitch is meant the perpendicular distance from said geometric plane to the second end of the wedge-facet.

In accordance with embodiments of the display apparatus as shown in FIG. 5 and FIG. 6, the basic parts, i.e. the light source 52/62, the light guide 53/63, the intermediate layer 59/69, and the display panel 51/61, are similar to those of the first embodiment, while the wedge angle increases with the distance from the light source 52/62. In a third embodiment, shown in FIG. 5, the microstructure is basically similar to the microstructure of the first embodiment. However, when the wedge angle increases, since the length of each wedge-facet 58, i.e. the distance between the first and second ends 58a, 58b of the wedge-facet 58, is the same, the wedge pitch also increases, and so does the size of the connection surfaces 59. Further, the length between two consecutive connection surfaces decreases with the distance from the light source 52. The inclination of the connection surfaces 59 is constant. In a fourth embodiment as shown in FIG. 6, the microstructure is basically similar to that of the second embodiment. What has just been said about the third embodiment is likewise true for this fourth embodiment. However, the variable size of the connection surfaces is limited to a variation of the first portion 64 thereof, while all second portions, extending in the geometric plane of the rear surface of the light guide, are equal in size. Of course there are many other combinations of property adjustments that also result in a desired improvement in illumination or some other parameter.

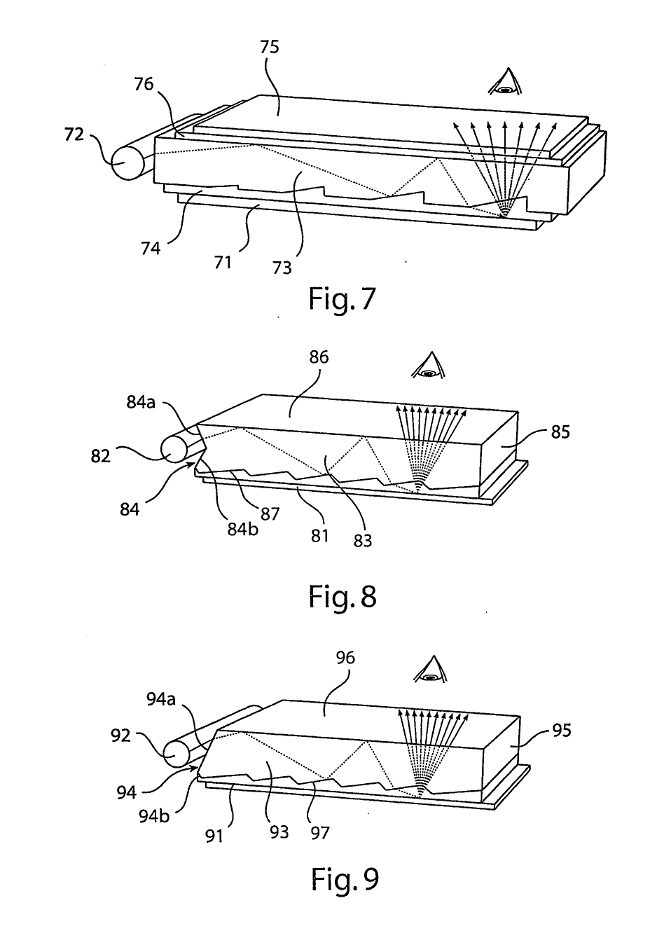

In FIG. 7 a fifth embodiment of the display apparatus of the present invention is shown. This embodiment comprises a display panel 71, a front light comprising a light source 72 and a light guide 73, a first intermediate layer 74, optically connecting the light guide to the display panel 71, a touch screen 75, and a second intermediate layer 76, optically connecting the touch screen 75 to the light guide 73. By making an appropriate choice of refractive indices of the second intermediate layer 75, the light guide 73 and the first intermediate layer 74, light will only be coupled out of the front light on the display panel side, and not on the touch screen side. If the refractive indices of the first intermediate layer 74, the second intermediate layer 75, and the light guide 73 are n₁, n₂, and n₃, respectively, their mutual relationship should be n₂<n₁<n₃. Thus, the second intermediate layer 75 should have the lowest refractive index, and the light guide 73 should have the highest. Preferably, the refractive index of the first intermediate layer should be significantly higher than that of the second intermediate layer 75 and, for instance, be chosen as the average value of the indices of refraction of the light guide and the second intermediate layer. Preferably, both intermediate layers 74, 75 are adhesives, such as UV-curable acrylates or thermally curable epoxies.

In order to further improve the illumination properties, in an sixth embodiment as shown in FIG. 8, the first end surface 84 of the light guide 83, i.e. the light entrance end surface where the light source 82 is located, is facetted. In other words, at least a portion of the first end surface 84 is inclined such that it is non-parallel to the opposite second end surface 85. Thus, said portion is non-perpendicular to the front surface 86 of the light guide 83. In accordance with this sixth embodiment, there is a first, or upper facet 84a, and a second, or lower facet 84b, which is adjacent to the first facet 84a. The first and second facets 84a,b form a V-shaped groove extending along the light entrance end surface 84, i.e. in parallel with the center axis of the light source 82. The first and second facets 84a, 84b are about equal in size, so that the bottom of the groove is located approximately in the middle between the front and rear surfaces 86, 87 of the light guide 83.

In accordance with a seventh embodiment, as shown in FIG. 9, the facetted entrance end surface comprises a first, or upper facet 94a, which extends from the front surface 96 of the light guide 93 towards the rear surface 97 thereof, and which occupies a major portion of the first end surface 94. In this embodiment the first facet 94a is inclined in the opposite direction to that of the previously described embodiment. That is, the distance from a point at the first facet 94a to the second end surface 95 of the light guide 93 is longer the closer to the rear surface 97 of the light guide 93 the point is. A second, or lower, facet 94b is adjacent to the first facet 94a, and is oppositely inclined.

Thus, in accordance with the present invention, a display apparatus is provided, which takes advantage of the inherent properties of a diffusely reflecting display panel, and includes a front light, which combines a substantially uniform thickness with relaxed quality demands, and which provides a tuneable illumination uniformity.

1. A display apparatus comprising a diffusely reflecting display panel (21, 41, 51, 61, 71, 81, 91), a front light comprising a light guide (23, 43, 53, 63, 73, 83, 93) and a light source (22, 42, 52, 62, 72, 82, 92) arranged at a first end (24, 84, 94) of the light guide and emitting light which enters into the light guide through said first end, and a transparent intermediate layer (29, 49, 59, 69) which is arranged between a front surface of said display panel and a rear surface (27, 47, 87, 97) of said light guide, such that the display panel is in optical contact with said light guide, wherein said rear surface of the light guide is provided with a microstructure comprising wedge-facets (28, 34a-c, 48, 58) which are arranged such that, for each wedge-facet, the distance between a first end (35a-c, 48a, 58a) of the wedge-facet and said front surface of the display panel is shorter than the distance between a second end (36a-b, 48b, 58b) of the wedge-facet and said front surface of the display panel, where said first end of the wedge-facet is positioned closer to the light source than said second end of the wedge-facet.

2. A display apparatus according to claim 1, wherein said wedge-facets are arranged consecutively along said rear surface of the light guide, between said first end and a second end thereof, which second end is opposite to said first end.

3. A display apparatus according to claim 2, wherein each two neighboring wedge-facets are connected by means of a connection surface (37a-b), which is non-parallel with said front surface of the display panel.

4. A display apparatus according to claim 2, wherein each two neighboring wedge-facets are connected by means of a connection surface (44, 45) which consists of a first portion (44) that is non-parallel with said front surface of the display panel and a second portion (45) that is parallel with said front surface of the display panel.

5. A display apparatus according to claim 2, wherein at least one wedge-facet property varies with the distance from said first end of the light guide.

6. A display apparatus according to claim 5, wherein said at least one wedge-facet property is chosen from of a group of wedge-facet properties consisting of the wedge angle, wedge length, the distance between two consecutive connection surfaces, and the wedge pitch.

7. A display apparatus according to claim 5, wherein said at least one wedge-facet property increases from said first end of the light guide towards said second end of the light guide.

8. A display apparatus according to claim 1, wherein an end surface of said first end (24, 84, 94) comprises a first facet (84a, 94a) being non-perpendicular to a front surface of said light guide.

9. A display apparatus according to claim 8, wherein said end surface comprises a second facet (84b), which is adjacent to said first facet, wherein said first and second facets form a V-shaped groove extending along said end surface.

10. A display apparatus according to claim 1, wherein said intermediate layer is an adhesive.

11. A display apparatus according to claim 1, wherein said intermediate layer has a refractive index that is lower than that of the light guide.

12. A display apparatus according to claim 11, further comprising a touch screen (75) and a second transparent intermediate layer (76) arranged between the touch screen and a front surface of said light guide, and bringing the touch screen into optical contact with the light guide.

13. A display apparatus according to claim 12, wherein said second transparent intermediate layer is an adhesive.

14. A display apparatus according to claim 12, wherein said second transparent intermediate layer has a refractive index that is lower than that of said first transparent intermediate layer.
